(19) United States
(12) Patent Application Publication
(10) Pub. No.: US 2026/0228083 A1
(43) Pub. Date: Aug. 6, 2026

(54) DETECTION AND CORRECTION OF ERRORS IN CONTROL SYSTEMS AND OPERATIONS

(71) Applicant: Saudi Arabian Oil Company, Dhahran (SA)

(72) Inventors: Yousif Al Ghamdi, Dhahran (SA); Aymen Lazaar, Dhahran (SA); Fahad K. Alghamdi, Udhailiyah (SA); Basil S. Abuhadi, Dhahran (SA)

(21) Appl. No.: 19/046,924

(22) Filed: Feb. 6, 2025

(51) Int. Cl. G06F 11/07

(52) U.S. Cl. CPC G06F 11/0793; G06F 11/0769; G06F 11/079

(57) ABSTRACT

A method for controlling an operations technology system of a hydrocarbon production facility, the method comprising: receiving technical alert (TA) data specifying one or more changes for implementing on a device; identifying one or more assets of an operations technology system that are associated with the TA, the one or more assets including the device; accessing a compliance model that integrates machine-learning algorithms to: classify inputs corresponding to an asset type and asset status of the identified one or more assets, and enable generation of a recommended action for mitigation an issue with the identified one or more assets based on the asset type and the asset status; performing a verification, based on local data generated at the asset, whether the recommended action was successful or not; and generating a report specifying the recommended action and whether the recommended action was successful or not.

### TECHNICAL FIELD

The present disclosure relates to identification and mitigation of errors that occur operations of control systems, such as control systems for drilling for hydrocarbons and processing hydrocarbons. Specifically, the techniques and systems described herein apply to adding feedback to control systems that update how errors in operations are identified and mitigated based on data describing previous recommendations for mitigation actions and analysis of the implementation of the previous recommendations.

### BACKGROUND

A system, device, or computer network may include multiple assets that provide a desired function. For example, a computer system or network can include several assets, such as routers, servers, or client devices, which enable individuals or users to access shared resources including a variety of digital content accessible by the Internet. In general, devices and assets such as those that access the internet and other networked resources (e.g., that are external to a local network) present a variety of security challenges. For example, the assets may be susceptible to unauthorized access, data breaches, or other attacks from malicious users.

These challenges and vulnerabilities drive compliance initiatives that specify controls that are required to protect an asset against security risks. Compliance management functions typically involve teams that assess the compliance of systems against a set of internal control requirements by testing for a documented control or a process associated with the control. This control can be any artefact on an example target system (e.g., computer system) such as the presence of a particular file, version of certain code, or a setting in a particular configuration file or registry key (to name but a few). Based on a number of successful test results, the target system can be assessed to determine whether it is compliant with a specified standard.

### SUMMARY

This application describes a system to detect technical alerts (TAs) for operation technologies (OT) subsystems within a larger system. TAs include data generated by a vendor that describe or affect operation of devices or systems called assets, as subsequently described. The TA generally includes an alert that specifies an issue or action to be taken with respect to an asset to update the operation of the asset. The system either automatically takes an action to mitigate a technical issue associated with the asset (such as preserving data security) or alerts an associated entity (such as a user) that a mitigation action is likely needed for the asset. The system provides that entity with a recommendation for the mitigation action. A computing system, such as a data processing system, is configured to detect a type of TA, select a particular model from a set of models based on the identified type of TA or identified vendor, apply the particular model, and determine (e.g., classify) a type of action to take to mitigate the issue or respond to the alert that was identified. The data processing system can cause execution of a recommended action in addition to providing the recommendation. The data processing system can generate the recommendation based on identified patterns that are identified by the selected model, which can include a machine learning (ML) model that is specialized or configured to detect a particular type of technical issue.

The data processing system can be a part of a control system that receives input from different remote systems or portions of remote systems at end-user sites. The remote systems or portions thereof can be called assets, as indicated previously. For an asset, the data processing system can automatically perform TA pulling, collection, assessment, analysis and notification via supply chain system or cloud environment. The data processing system can automate TA processing by accessing and/or fetching TAs from a centralized repository including instances of vendor TAs that are automatically collected from vendor databases over secure interfaces.

The data processing system can review TAs provided by various vendors or other entities associated with the asset. The data processing system can automate the alerts analysis and assessment. The data processing system can process, using specialized ML models, the alert details. The data processing system, as a result, can notify the relevant asset based on its respective alerts and associated information (such as criticality, impacted system information, and so forth) and generate a recommendation of mitigation or response actions. This enables the asset (or portion thereof) such they can take the right timely action.

The data processing system can enable assets (or agents representing the assets) to submit queries (e.g., through a chatbot) about relevant alerts for the asset, check TA applicability to the asset systems, and gather any details about mitigation. The data processing system includes verification logic to automatically ensure, if needed, that impacted organizations associate with the assets have implemented the mitigation.

The one or more embodiments described in this specification can enable one or more of the following advantages. The data processing system can provide new and efficient data structures, enhancing overall data processing speed/efficiency, implementing/improving data security, and eliminate issues caused by inadequate mitigation and/or unverified implementation of mitigation recommendations. For example, the data processing system can enable responses to TA suggesting processing bottlenecks or slow processing speed from various assets in large scale computing contexts. The data processing system can scan the status of the system, and based on historical data, prior asset failure, a vendor type and asset type, the data processing system can adjust the scanning of the device correspondingly and update processing loads to avoid loading a processor associated with the asset. In some implementations, a generated TA or other alarm or alert data in assets can be deleted once they are transferred to the central repository, releasing storage at the asset. The data processing system can replace alarm analytics performed by the asset, and instead directly receive asset data (e.g., sensor signals or other data) and analyze it independent from processing at the asset. The results of the analysis can eb used to update local ML models at the data processing system. For example, if the ML/AI recommends mitigation, the mitigation is performed, and the result is validated as a success (or identified as a failure), the result can be used to further update and/or refine the ML model that made the classification that led to a recommendation and result success or failure. The ML models can be trained on local data to a specific asset and by global data for other asset instances, or, where applicable, for other asset types. In some implementations, if a mitigation fails, the data processing system reverts to an alternative (e.g., previous) mitigation that was used before executing the recommended action by utilizing a saved image for the asset. For example, the data processing system can adjust a mitigation based on a critically of the failure if it adversely affects asset performance. In some implementations, the data processing system can evaluate or simulate whether executing the action will cause disturbance or shutdown to the end system. The vendor TA statement may identify this result, but the end user should be able to automate such a determination. The end user can approve or reject the condition (e.g., the proposed action) until a suitable planned shutdown window for the target asset (or its system) is available.

The data processing system includes a unique database structure that is updated frequently using a verification engine. The verification engine scans the assets and updates the database based on determined implantation of a recommendation and determination of success for failure. To use the historical database and prioritize a result, as the verification engine scans assets of the network, the data processing system generates a hierarchy for better tracking of system and classification of TAs. The data processing system can set the scanning time to avoid overload of the network based on historical data associated with the asset and the asset type. For example, input/output (IO) cards are likely to be changed or replaced faster than a controller, and the priority for scanning is IO cards higher than controllers. Stable system or devices have lower scanning rates based on failure rate analysis, reducing computing overhead. These statistics can be shared with the vendor to provide good database knowledge to enable vendors to improve their assets. For example, the vendor can certify “prior use” type ‘A’ devices.

The advantages can be enabled by one or more of the following aspects, embodiments, or implementations.

In an aspect, a method for controlling an operations technology system of a hydrocarbon production facility includes receiving technical alert (TA) data specifying one or more changes for implementing on a device; identifying one or more assets of an operations technology system that are associated with the TA, the one or more assets including the device; accessing a compliance model that integrates machine-learning algorithms to: classify inputs corresponding to an asset type and asset status of the identified one or more assets, and enable generation of a recommended action for mitigation an issue with the identified one or more assets based on the asset type and the asset status; performing a verification, based on local data generated at the asset, whether the recommended action was successful or not; and generating a report specifying the recommended action and whether the recommended action was successful or not.

In some implementations, the method includes training the compliance model by: querying data from a verifier installed at an operations technology layer including the identified one or more assets; determining variance data of asset data for the one or more assets compared to expected data for the one or more assets; updating asset data with the variance data; labelling the recommended action with the variance data to generate labelled data; and retraining the compliance model using the labelled data.

In some implementations, the one or more assets include physical hardware in a hydrocarbon production facility, and wherein the recommended action includes controlling operation of the hardware.

In some implementations, controlling operation of the hardware comprises quarantining the hardware from transmitting or receiving data from other assets of the operational technology system.

In some implementations, the method includes generating a validation request for approval by a user prior to implementing the recommended action, wherein generating the validation request is based on a confidence of a prediction of the recommended action.

In some implementations, the method includes classifying the TA data based on a source of the TA data, wherein the generation of the recommended action is based on the source of the TA data.

In some implementations, the method includes, responsive to determining that the recommended action was not successful, reverting operation of the one or more assets to a state prior to detection of an issue related to the TA data.

The previously described implementations and aspects are implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The details of one or more embodiments are set forth in the accompanying drawings and the description below. Other features and advantages will be apparent from the description and drawings, and from the claims.

### DESCRIPTION OF DRAWINGS

FIG. 1 shows an example of a networked system.

FIG. 2 illustrates an example computing environment.

FIG. 3A shows a process to generate recommended actions for identified TAs from vendor systems.

FIG. 3B shows a process to update the asset data based on whether a recommended action of FIG. 3A was successful or not.

FIG. 3C shows a process for verification of success or failure of an action.

FIG. 4 shows a block diagram illustrating an example process for controlling an operations technology system of a hydrocarbon production facility for mitigation of issues in OT systems.

FIG. 5 illustrates hydrocarbon production operations.

FIG. 6 is a diagram of an example computing system.

Like reference numbers and designations in the various drawings indicate like elements.

### DETAILED DESCRIPTION

A data processing system detects TAs for operation technologies subsystems within a larger network and classify those TAs to mitigate faults or errors within the network. Operational technology (OT) is hardware and software that detects or causes a change of operation, through the direct monitoring and/or control, of industrial equipment or other assets within an entity or process, such as within a hydrocarbon extraction facility or hydrocarbon extraction process. OT systems, including hardware and software systems, can control valves, engines, conveyors and other machines to regulate various process values, such as temperature, pressure, flow, and to monitor them to prevent hazardous conditions. OT systems use various technologies for hardware design and communications protocols, that are unknown in standard information technology (IT). For example, common problems include supporting legacy systems and devices and numerous vendor architectures and standards.

Because OT systems can be used to control or to supervise industrial processes, availability is sustained almost all the time for the devices and software of the OT systems. In some implementations, OT systems rely on real time (or near-real time) processing with high rates of reliability and availability. OT systems can include programmable logic controllers (PLCs), supervisory control and data acquisition systems (SCADA), distributed control systems (DCS), computer numerical control (CNC) systems, including computerized machine tools, scientific equipment (e.g. digital oscilloscopes), building management system (BMS) and building automation systems (BAS), lighting controls both for internal and external applications, energy monitoring, security and safety systems, valve and flow controls, transportation systems, and so forth. Other assets or systems can include burner management systems (BMS); emergency shut down systems (ESD); remote terminal units (RTU); leak detection systems (LDS), compressor control system (CCS) and anti-surge control systems; vibration monitoring systems (VMS), corrosion monitoring systems (CMS), turbine control system (TCS), terminal management systems (TMS), high integrity protection system (HIPS), instrument asset management system (IAMS), alarm management systems (ALMS), servers, network time protocol systems (NPS), firewalls, and switches.

OT systems and devices can be supported by a variety of vendors. Each vendor my send TAs (or TA data) to update, upgrade, or otherwise change operation of a device or system within the OT system of an entity. At scale, there can be a large number of TAs that are constantly generated to update or change portions of the OT system. The TA data can be provided in a number of different formats and/or at irregular cadences from different vendors. Each of the TAs can indicate a mitigation action (or other recommended action) to change a target asset within the OT system of an entity. It can become difficult to verify if each recommended action is applied to its respective targeted asset in a timely manner, which may prevent system failure.

OT often control and monitor important industrial processes, critical infrastructure, and other physical devices. OT systems can be vital for the proper functioning of industries such as manufacturing, power generation, and transportation. The data processing system can mitigate or eliminate common issues with OT systems, such as vulnerabilities and attack vectors that are a result of not implementing the recommended action of TAs to the associated target assets in a timely manner. The data processing system can prevent legacy systems from having outdated technology, as many OT networks still rely on older hardware and software that may not have been designed with security in mind, making them more susceptible to cyberattacks. The data processing system can prevent a lack of segmentation, in which inadequate network segmentation allows a compromised device in one part of the network to allow an attacker to access other parts of the network. The data processing system can prevent assets of the OT system from having weak authentication mechanisms and access controls that can enable unauthorized users to gain access to sensitive systems and data. The data processing system can prevent target assets from using insecure communication protocols that lack encryption or other security features, making them vulnerable to eavesdropping and data tampering. The data processing system enables high visibility and monitoring of OT networks to detect and respond to potential security incidents quickly. The data processing system mitigates supply chain risks that allow compromised hardware or software components in the OT network to introduce vulnerabilities that attackers can exploit.

The data processing system can determine which assets of an OT system apply to a given TA and cause the recommended action to occur. For example, the data processing system can automatically take an action to mitigate a technical issue (such as preserving data security). The data processing system can alert an associated entity (such as a user) that a mitigation action is needed. The data processing system provides that entity with a recommendation for the mitigation action. In some implementations, the data processing system executes the recommendation automatically by causing a recommended action to occur, such as updating asset firmware, shutting an asset down, quarantining an asset with a data quarantine, restricting user access to an asset, patch asset system files, revise or patch asset software, or a similar action.

The data processing system can quickly and accurately associate a TA with the target asset and apply the recommended action to mitigate a risk or issue. Because OT systems are often used for always-on or time critical systems like real-time control systems, the data processing system enables time sensitive actions from TAs to be implemented immediately to minimize or eliminate risk.

In some implementations, the data processing system can enable a system owner to determine whether a mitigation action can be taken automatically or whether an approval or verification is needed prior to implementing the mitigation action. The data processing system can enable a system owner to allow a time sensitive mitigation action to be performed immediately while also allowing verification of mitigation actions that are not time critical. A user interface can enable the system owner to configure the response taken when a mitigation action is recommended, even when the action is recommended with a high confidence (e.g., a high score) by one or more classifiers.

In some implementations, the data processing system can be configured to ensure continuous system feedback can occur, even in situations in which the operational technology layer has a strong cybersecurity mechanism. For example, the data processing system can cause firmware for a targeted asset to be updated and then verify that the update was successful. The data processing system can be installed at each OT layer to ensure continuous feedback can occur.

In some implementations, the action of the TA may stop the data processing system from communicating with the asset or end user system to perform recommended action. Rather, a decision of executing the recommendation or reverting back to an existing configuration in the asset system is based on an end user decision. Because executing TA may stop ports of some of communication which may affect the data processing system receiving feedback, the action can be split into parts. When the action is split to parts, end users may have the ability to execute the complete TA recommendation and accommodate the action that severs communication with the asset of a specific site or device. In some implementations, the recommendation may have timer to reset the action if communication is lost to the data processing system. An image of a legacy configuration can be used from the system or created by the data processing system before executing the changes of the recommended action to enable fallback to the previous state. Existing images dates or signatures can be verified if it matched the current installed base before generation of a new image or executing recommended actions.

In some implementations, a vendor TA may not allow the data processing system to fetch the TA data from their database directly. The data processing system can obtain TA data indirectly buy scanning published documents and automatically recreating the TA data from the scanned data.

In some implementations, it may be difficult to identify a given asset type by sniffing data from the device itself, because some devices are indistinguishable compared to other assets from same or different vendor. The data processing system can request a special digital mark or identity can be requested from each vendor to enable reading data of their system details and statuses. These and other embodiments are now described with respect to the figures.

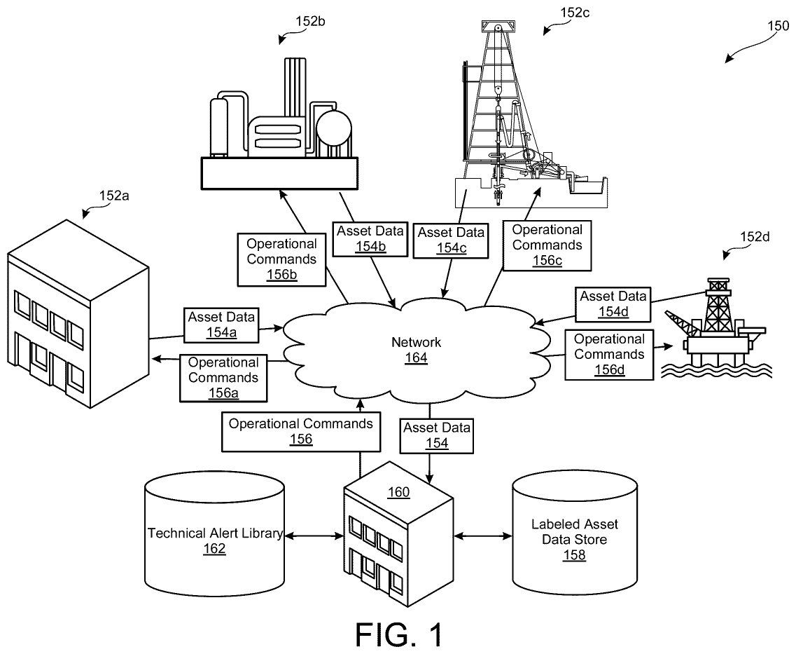

FIG. 1 shows a system 150 for hydrocarbon production. The system 150 includes a plurality of end-user sites 152a-d (collectively end-user sites 152), a control center 160, and a network 164. The end-user sites 152 can include one or more monitoring and control centers 152a, one or more refining operations facilities 152b, one or more wells 152c in the field, one or more drilling platforms 152d, and so forth. The end-user sites 152 are connected by a network 164 to a central control center 160 that monitors functionality of devices and systems within each of the end-user sites.

The end-user sites 152 are at various locations and can each include one or more assets. An asset includes a system or device that affects production operations and that is a part of an operation technologies (OT) systems within a network 164. Assets can include devices such as network hardware, including controllers, data processors, I/O interfaces and networking cards, sensors, routers switches, servers, load balancers, storage area networks, wireless access points, client devices such as personal computers, and hardware such as cables that are monitored by or associated with computing systems. Assets may also include software modules or programs such as firewalls intrusion detection systems, addressing systems, databases (e.g., data warehouse infrastructure), software modules or third party programs, portals and system interfaces, and so forth. The assets can include third party devices or software that are periodically updated by a vendor that supports the asset functionality.

Each of the end-user sites 152 can generate respective asset data 154a-d (collectively asset data 154) and send the asset data to the central control center 160. The asset data 154 describes operation of a respective asset at an end-user site. In some implementations, the asset data 154 includes status information about how hardware is functioning. For example, asset data 154 may indicate that an asset has lost power, is shut down, is unresponsive or has a high latency in response times, is consuming extra power relative to an expected power consumption, or other status. In some implementations, the asset data 154 includes sensor readings such as a temperature, pressure, position, or other reading associated with an asset. The asset data 154 may include data describing a software status, such as a software version number, firmware version number, date of previous updates or scans of the software, software performance, and so forth. The asset data 154 may include data describing data processing, such as processing load, errors or faults that occur, system resets, system administrators and responsible entities, and so forth. The asset data 154 can describe an identity of an asset, a location of the asset, a manufacturer of the asset or vendor associated with the asset, a list of technical alerts associated with the asset, or similar information.

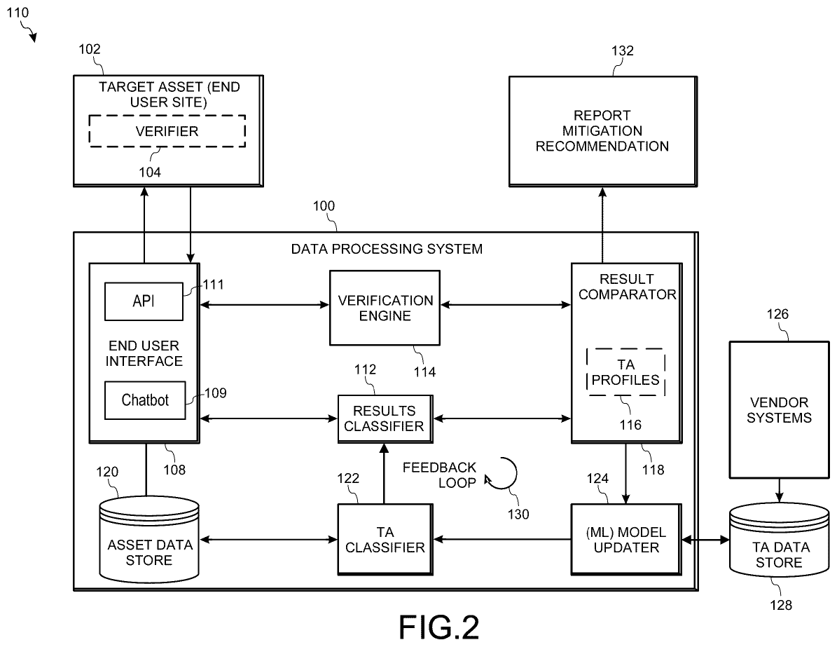

The central control center 160 includes a computing system, such as a data processing system 100 described in relation to FIG. 2. The data processing system at the control center is configured to retrieve technical alerts (TAs) from vendors (not shown) and store the TAs in a technical alert library 162. The data processing system of the central control center 160 can collect asset data 154 and of the assets and determine whether one or more TAs that have been fetched and stored in the TA library 162 are applicable to one or more assets associated with the asset data 154. As described herein, if a TA is applicable to an asset, the data processing system of the central control center 160 can determine whether a mitigation action is recommended for fixing an issue with the asset. In some implementations, the data processing system can generate operational commands 156a-d (collectively operational comments 156) for sending to respective end-user sites 152a-d. The operational commands can include instructions or control data to mitigate an asset issue, change asset functionality, update asset software, quarantine an asset, or perform some other function for the asset. The data processing system of the central control center 160, as described herein, can verify whether the recommended action was successful or unsuccessful in accomplishing a goal or solving an issue designated in the TA. The data processing system can associate the asset data, recommended mitigation and its success or failure, associated TA, and any other relevant data in a labeled asset data store 158. As described herein, the central control center 160 can execute one or more machine learning (ML) models to determine the recommended action in the operational commands 156. The central control center 160 can update the logic of the ML models using the labeled asset data in the data store 158.

FIG. 2 illustrates an example computing environment 110 including a data processing system 100 configured to detect a type of technical alert, select a particular model from a set of models based on the identified type of TA or identified vendor, apply the particular model, and determine (e.g., classify) a type of action to take to mitigate the issue or respond to the alert that was identified, as described in relation to FIG. 1. The data processing system 100 can cause execution of a recommended action in addition to providing the recommendation. The data processing system can generate the recommendation based on identified patterns that are identified by the selected model, which can include a ML model that is specialized or configured to detect a particular type of technical issue, as subsequently described.

The data processing system 100 can be a part of a control system (such as control center 160 of FIG. 1) that receives input from different remote systems (such as end-user sites 152) or portions of remote systems at end-user sites. The remote systems or portions thereof can be assets, as described previously. For an asset, the data processing system 100 can automatically perform TA pulling, collection, assessment, analysis and notification by a supply chain system or cloud environment. The data processing system 100 can automate TA processing by accessing TAs from a centralized repository including instances of vendor TAs that are automatically collected from vendor databases over secure interfaces.

The data processing system 100 can review TAs provided by various vendors or other entities associated with an asset. In this disclosure, processing a TA refers to processing any data included in the TA. The data processing system can automate the alerts analysis and assessment. The data processing system can process the TA using specialized ML models that are trained based on the library of TAs (e.g., TA data store 128) to classify the TA and identify related assets. The data processing system 100 can generate a recommended mitigation action using one or more specialized ML models associated with the asset, trained using the asset data store 120. The data processing system, as a result, can notify the relevant asset (or an entity associated with the asset, such as an owner) based on its respective alerts and associated information (such as criticality, impacted system information, and so forth). The data processing system 100 generates the recommendation of a mitigation action or other response action to be performed automatically by the data processing system 100 or to be performed by an entity associated with the asset. The data processing system 100 enables the asset (or portion thereof) to perform the mitigation action in a timely manner.

The data processing system 100 includes a set of modules for fetching TA data from vendors, asset data from end users, processing these data, and causing issue mitigation to be performed. An end user interface 108 interfaces with end user sites for receiving operational data from assets of the end user sites (and their target assets 102) and receiving other queries from remote users (such as application programming interface (API) queries, chatbot queries, etc.). A verification engine 114 verifies whether recommended actions have been implemented at end user sites and whether the recommended action was successful or unsuccessful in mitigation of the issue identified in the TA associated with the recommendation. A TA classifier 122 classifies the TA and determines which asset(s) of one or more end user sites are impacted. A results classifier 112 generates recommendations for mitigation actions based on the TA and impacted asset(s) identified by the TA classifier 122.

A results comparator 118 updates TA profiles 116 based on whether the implemented recommended action was successful or unsuccessful in resolving the issue identified in a TA. The (machine learning) model updater 124 can update the models used for classification of TAs and recommendation generation (e.g., TA classifier 122 and results classifier 112).

The ML model updater 124 updates the classifiers 112, 122 in a feedback loop 130. When new TAs are received in the TA data store 128, the ML model updater can determine whether a new classifier is to be trained to process the TA or whether an existing classifier can be updated to process the TA.

A TA data store 128 includes a data store that receives TAs from third party vendor systems 128. The TA data store can fetch TA data from vendor systems 126 periodically or responsive to indication form the vendor systems that TA data are newly available. The TA data can include a TA type that indicates one or more actions generally associated with the TA. The TA data can include an asset type that indicates a target asset for that TA. The TA data can include a vendor identifier that identifies the publisher of the TA data. In examples in which one or more of these data fields are omitted, the data processing system 100 can infer the value of the field based on other data included the TA or associated with the TA, such as where the TA originated from (e.g., an internet protocol address). As discussed below, these data can assist the data processing system 100 in determining which target asset 102 is affected by the TA and which action to recommend mitigating an issue.

The target asset 102 can be a physical item, a digital item, or both. For example, the target asset 102 can be a computing device or a computer network (e.g., local area network) of a business entity. In some instances, the target asset 102 is an operating system of a computing device, an application program of an operating system, individual servers of a computer network, or a combination of these. In this these instances, the target asset 102 can include an application program (e.g., a native application or “app”) of an operating system, processing devices or data serving protocols of a server, a computing node of the network, or a combination of these. As previously indicated, an asset can include programmable logic controllers (PLCs), supervisory control and data acquisition systems (SCADA), distributed control systems (DCS), computer numerical control (CNC) systems, including computerized machine tools, scientific equipment (e.g. digital oscilloscopes), building management system (BMS) and building automation systems (BAS), lighting controls both for internal and external applications, energy monitoring, security and safety systems, valve and flow controls, transportation systems, and so forth. The asset can be associated with system controls 102 that operate one or more physical systems, such as pumps, valves, or OT systems as previously discussed. For example, in some implementations, the OT system is a physical construct such as a commercial building. In this these instances, target assets 102 of the OT system can include digital and physical locks, electronic access points that restrict or permit access to the physical construct, a property monitoring system that monitors the construct, or a combination of these. In general, a target asset 102 can be any software or hardware item for which a control has been developed or specified to protect the asset against an identified risk.

The data processing system 100 can enable target assets (or agents representing the assets) to submit queries through an end-user interface 108. The end-user interface 108 can be any kind of interface to enable the asset (or its agent) to communicate with the data processing system 100, For example, the end-user interface 108 can include an API 111 that enables interaction directly between devices systems. In another example, the end-user interface can include a rendered graphical user interface. In some implementations, the end-user interface 108 can include natural language processing (NLP) system such as a chatbot 109 that takes user queries directly from end users. The interface 108 enables the asset to query about relevant TAs for the asset, check TA applicability to the asset or controlled systems of the asset, and/or gather any details about mitigation of issues related to the asset. The interface 108 also enables the data processing system 100 to query data from a target asset 102, such as to acquire data (e.g., by packet sniffing or other means) from the target asset to determine whether there is an issue to be corrected at the target asset.

The verification engine 114 automatically ensure, if needed, that impacted organizations associate with the assets have implemented the mitigation. that implements compliance verification testing using negative validation. The system 100 can be an example verification system configured to implement negative validation or positive validation to perform compliance verification, as described in detail below.

The verification engine 114 includes one or more datasets for implementing compliance verification testing of the recommended action and whether it was successfully implemented at the target asset 102 or not. The verification engine 106 includes a dataset of requirements that indicate that the recommended action for the target asset 102 was successful. For example, if the recommended action is a software patch installation, the verification engine 112, through interface 108, can check the version number for the related installed software on the target asset 102. Other such verification can occur, such as checking sensor data values of an asset, measuring data throughput at an asset, and so forth.

The requirements data of the verification engine 114 can be derived from baseline documentation that includes information about the target asset(s) 102, such as from asset data store 120. The asset data store 120 can be populated by requesting relevant data (through interface 108) from new assets as they are detected in the OT system or as they are added to the OT system. The asset data store 120 includes a library of asset information that is updated as the recommended actions of TAs are implemented at actual assets in the OT system.

In some implementations, the requirements data can represent a defined list of detectable asset status or functionalities that are collated into a digital or electronic documents. These digital documents can include information that describes how to assess a functionality of a target asset 102 relative to a set of internal or external requirements that are specific to the asset or other devices associated with the asset. In some instances, the documents may be proprietary to a given organization, based on their internal requirements, or standardized by a specific vendor for general implementation.

The verification engine 114 can interact with a software and/or hardware verifier 104 that can execute on OT systems that include the target assets 102. The verifier 104 and verification engine 114 can determine, for example, a system and version specification of asset hardware/software to populate the asset data store 120 of the data processing system 100 automatically. The verifier 104 and verification engine 114 can assisting the verification process for determining whether a recommended action of a TA was successfully implemented at the site of the target asset 102. In some implementations, the verifier 104 can include an independent software tool including a field-based system. The field-based system is installed in the process control domain of the OT system. The verifier 104 can enable fetching the installed base and developing an inventory list. The verifier 104 can collect system software revisions including patches and fixes revisions and update the asset data store 120. The verifier 104 can push collected information, such as installed basis, inventory database, hot fixes status, and so forth, to the data processing system 100 and allow for integrated API or robotic process automation (through the verification engine 114) to perform the verification checks. The verifier 104 can generate reports on an asset 102 health and/or perform condition crosschecking on the installed system status and allow the result comparator 118 to compare the expected status of the asset with the reported status of the asset. The verifier 104 can generate a report on any uncontrolled or un-signed patching. In some implementations, the verifier 104 can provide an offline report by generating files and/or reports that can serve system integrity check. These files and/or reports can be retrieved through local networks or through other means.

The field-based verifier 104 can be versatile to adapt to any asset, including control systems, networks, cloud systems, and so forth. For example, the verifier 104 integrates the software within an industrial computing processor of an asset with networking and security capability of the OT system that includes the data processing system 100. The verifier 104 can include API capabilities of to handle all types of asset devices and software and send these data to the data processing system 100 through the interface 108.

The asset data store 120 can include a database of TAs (the TA data store 128) and corresponding recommended actions. The data processing system 100 can update models 122 for classifying TAs by analyzing TAs and queries associated with the asset 102 received through the interface 108. As previously indicated, the queries can be retrieved through an interface by NLP. In some implementations, the data processing system determines an asset type by reading digital signature of devices with a network model. The network model can be integrated with the NLP, a relational model (to detect vendor and TA types), and a JSON model (for NLP).

The data processing system 100 is configured to fetch TAs from vendor systems 126 and populate a TA data store 128 with TA data. In some implementations, the data processing system 100 can periodically query vendor systems to obtain the TA data. In some implementations, vendors can publish or push TA data that is received by the data processing system and stored in the TA data store 128. Vendor systems 126 can be active, such as support systems that transmit alerts, or passive, such as vendor websites or other databases that are accessed by the data processing system 100 to retrieve the TA data.

When new TA data are retrieved, the TA classifier 122 identifies the relevant target asset 102. The results classifier 112 generates recommendations for mitigation actions based on the TA and impacted asset(s) identified by the TA classifier 122. The data processing system 100 attempts to apply the recommended action to the target asset 102 through the interface 108. The data processing system uses TA profiles data 116 to relate target assets 102 identified in the asset data store 120 to TAs of the TA data store 128.

The data processing system attempts to apply the recommended action when the target asset is identified. The success or failure of the action is checked by the verification engine 114, as previously described. Based on the determined outcome (a verified failure or success), the classifiers 112, 122 can be updated if needed. The result comparator 108 updates the TA profiles data 116 to reflect the success for failure. For a success, the data processing system 100 increases a confidence of the classifiers 112, 122 for the results that each output for the input data. For a failure, the data processing system 100 determines whether the wrong TA was identified or whether the wrong action was recommended. To determine whether the wrong TA was identified, the results comparator 108 can check the TA data store 128 for another TA that matches the classified TA or request user verification. To determine whether the wrong action was identified, the results comparator 108 cause a different recommended action to occur and verify if the action was successful or request user validation. The ML model updater 124 receives the labeled result (success or failure) from the results comparator 108 and updates the classifiers 112, 122 with the labeled result of their prior classifications to train the classifiers 112, 122 over time. If there are repeated failures that are not announced by vendors by the invention detected and found similar pattern among them, the data processing system 102 reports this to the data store 128.

The TA classifier 122 can classify the TAs based on data included in the TA and associated with the TA. For example, the TA classifier 122 can identify an internet protocol (IP) address or username associated with the TA. The TA classifier 122 can process data a manufacturing vendor who generated the TA. In some implementations, the TAs are certified by the manufacturer. In some implementations, end users identify or submit non-certified TAs to the data processing system 100. The non-certified TAs can be reviewed by the manufacturing vendor associated with the asset that had the alert and by other end users for support or awareness using the feedback provided by other end users. The data processing system 100 can process additional feedback data from both the manufacturing vendor and other end users to update the TA classifier 122 and/or results classifier 112 to better associate TAs with target assets 102 and propose successful recommendations.

The data processing system 100 improves the classifiers 112, 122 over time in a feedback loop 130. As indicated previously, based on verification of a recommended action success or failure by the verification engine 114, the results classifier 112 can re-score a given recommendation that was made for a particular TA. In addition, the TA classifier 122 can re-score a classified TA type when the recommended action is not successful, as it is possible that the wrong TA was identified to respond to an issue identified at an asset. The ML model updater 124 can provide labeled results data (from the result comparator 118) that is used to further train each of the results classifier 112 and the TA classifier 122. In some implementations, the results classifier 118 can also label a successfully implemented recommendation with the identified TA and asset 102. In this way, the data processing system 100 can learn to automate one TA from single vendor for automating other TAs from the vendor. The data processing system 100 can learn to implement a particular action to help automate other action items for the same TA type from other vendors.

The data processing system 100 generates a notification to end users that includes a report at interface 132. The report at interface 132 includes a recommended action for implementation on a target asset 102. In some implementations, the report at interface 132 indicates whether automated implementation of the recommended action was successful or not. In some implementations, the report at interface 132 requests end user verification that the recommended action should be implemented. In some implementations, the report at interface 132 indicates a recommended action for the end user to perform.

Various asset diagnostics can indicate success or failure of the recommended action of the selected TA. For example, the system can measure processing usage or power usage, random access memory usage (or other memory usage), network traffic data, device heartbeat or watchdog indicators, compare expected data to measured data generated by the asset, determine if downstream processes are performing as expected, and so forth.

In some implementations, the verification engine 114 uses a score to characterize the assessment or evaluation of recommended action at the target asset 102. For example, verification engine can check data of the target asset and use it to determine (e.g., along with comparator 118) whether the asset data matches expected data if the recommended action were successfully implemented.

As discussed earlier, the classifiers 112, 122 can generate scores based on one or more machine-learning (ML) algorithms and/or data models. At least one algorithm is associated with a mathematical model that utilizes a set of negative test cases to verify positive results. Some (or all) of the algorithms are agnostic to the underlying technology that is being tested. In some implementations, at least one algorithm associated with the mathematical model can be integrated into supervised and unsupervised machine learning algorithms to further automate classification and prediction capabilities.

The classifiers 112, 122 can be based on one or more individual data models, where at least one data model integrates ML algorithms to classify inputs corresponding to a compliance test as well as to enable predictive analytics of the compliance model using the classified inputs. The data models may be based on different types of machine-learning technologies and trained in response to processing data values of the input dataset in accordance with algorithms for the technology. In some implementations, the classifiers 112, 122 can each utilize a supervised machine learning algorithm to classify input data (e.g., using decision trees) and an unsupervised algorithm to detect patterns (e.g., using association analysis) whereby future areas of concern can be predicted. Reinforcement learning can also be used, as described herein.

The data processing system 100 can include a training phase and an implementation phase. During the training phase, the classifiers are trained based on verified information (e.g., a training dataset) stored in the TA data store 128 and/or the asset data store 120. The data stores 120, 128 can be organized as specific asset type test cases, where the results of testing controls for individual assets are organized under a corresponding asset type.

The classifiers 112, 122 can execute or manage the processing of an initial data set of test case results to train one or more data models. In some implementations, the classifiers 112, 122 may be based on neural networks. In some implementations, each of the classifiers 112, 122 may be based on a single neural network or multiple neural networks. In some other implementations, the classifiers 112, 122 can be based on, or include, other types of machine-learning technologies, such as a feature generator, a support vector machine, a Bayesian network, or other related machine-learning technology.

The data processing system 100 improves the classifiers 112, 122 over time as more technical alerts are analyzed. For example, training the classifiers 112, 122 on a first TA instance can assist the data processing system 100 for implementing recommended actions for other instances of the TA. In some implementations, training the classifiers 112, 122 on a number of recommended actions (e.g., by determining successful or unsuccessful implementation) can improve future recommendations for TAs or for other TAs from one or more vendors. For example, training the classifiers 112, 122 on a first TA from a vendor can assist the classifiers 112, 122 on analysis of other TAs for that vendor. In another example, training the classifiers 112, 122 on the TA for a vendor can assist the classifiers 112, 122 for processing similar TAs from other vendors. In some implementations, training the classifiers 112, 122 on a recommended action for a TA can assist recommendations based on other instances of the TA or other TA types from one or more vendors. As the number of examples increases, the recommendations for actions are more often successful.

The TA classifier 122 can be trained on known data for further classification. For example, the TA classifier 122 can be trained based on a website of a vendor, a vendor name in a comment, an installed base vendor database for the facility or operational technology system hosting the target asset, and similar information.

The results classifier 112 can be trained to determine a correct action is based on verified data. The verified data can include previous TA data that is verified manually and that can be used as training model, scanning keywords of action items, continuous checking if action items were successful, and based on similarities between common TAs or vendors.

The data stores 120, 128 can include labeled data for training the classifiers 112, 122. The data stores 120, 128 can include vendor lists details, installed base details and locations, technical alerts documents and texts, and similar information.

The data processing system 100 can identify issues with assets to begin the process of implanting a recommended action based on data from the assets. The asset data can include data gathered from system diagnostics. The recommended actions can be responsive to data such as an asset having a bad indicator such as high processor usage, high error rates or failures relative to other systems, showing similar diagnostic information as previously analyzed assets that required mitigation, and so forth. In some implementations, if a particular asset shows an error or has an identified issue, connected or related assets in the same system can be checked. In some implementations, if an asset has not been checked for longer than a threshold period of time, or no TA action has been implemented for the asset for a threshold period of time, a new check is performed. Asset data such as heartbeat data, watchdog data, and similar diagnostics of update and checking are used to identify assets for implementation of a TA.

The data processing system uses closed loops, as indicated previously, to improve prediction and recommendations over time. The data processing system 100 receives feedback to correct the error or update itself by determining whether a recommended action was successful. The data processing system 100 can update itself based on changes to an installed asset database in which the asset database is updated with hardware, firmware, software versions continuously as exist in the operation technology system. The data processing system 100 can update based on changes to the TA data store 128 in which updates to relevant TAs from vendors occur (automatically or responsive to alerts from vendors). The data processing system detects if there is a change or new update. The data processing system 100 updates itself based on action item verification in which the data processing system updates the TA patches and correctness of the result to the database from the verifier like the success of execution. The data processing system can list errors when they occur after the update for verification of system performance. The data processing system 100 generates feedback to the vendors if the recommendations were a success or a failure regarding actual results when TA actions are executed.

As indicated previously, the data processing system 100 reports the recommended action to the end user at interface 132. In some implementations, the user has the option to approve/reject/direct action items that are analysis evaluated while seeing the confidence of the result and reasons of why an action was recommended by either of the classifiers 112, 122. For example, if the level of confidence is more than a high threshold, the AI can accept the action with right classification and details automatically. For example, if the level of confidence is more than a medium threshold, the AI will give option to user to approve/reject/direct with preference to approve. For example, if the level of confidence is less than a medium or low threshold, the AI will give option to user to approve/reject/direct with preference to reject/direct. The more the classifiers are trained for specific TAs or vendors, the more often the training models will exceed the high confidence threshold. Similarly, the more the classifiers are trained with a number of actions and their associated TAs, the more often the training models will exceed the high confidence threshold.

The interface 132 can include a dashboard and flag alerts on system conditions. The interface 132 can be included in OT/IT network dashboards of system. The interface 132 can show a compliance for TAs and a last-checked status on any database checker of all of the system, databases, TA, action items, and the installed asset base.

In some implementations, the data processing system 100 can check if the performed action items were not successfully executed or abnormal behavior were not expected. For example, if many alerts are introduced with a low performance, the data processing system 100 can cause the OT system to revert to an old action or firmware version and report this to the source of TA (vendor) with diagnostics error and expected results. The vendor can check specific expected digital signature after executing action items to verify the execution process success. The data processing system 100 can generate a recommendation if the action items imply a physical replacement. The recommendation is provided to a responsible entity to redo the action based on generative intelligent feedback as described previously.

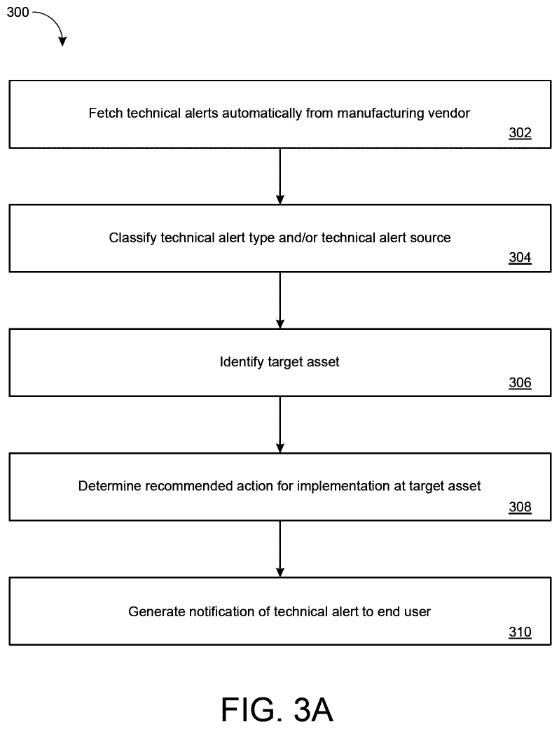

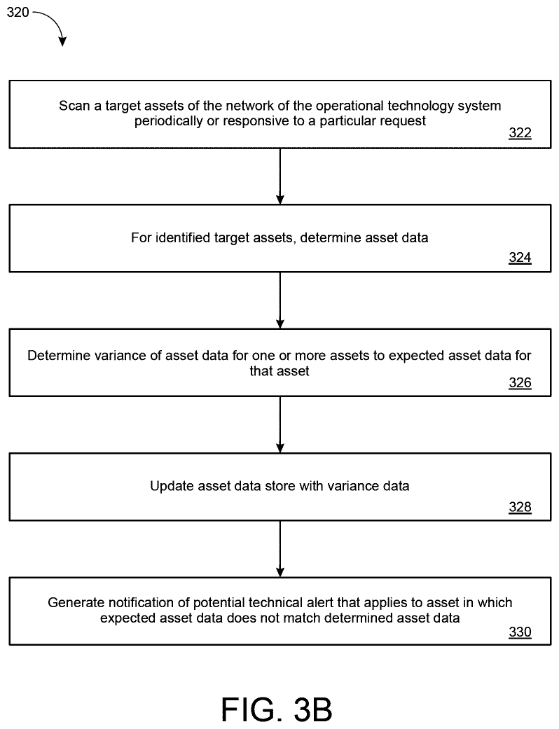

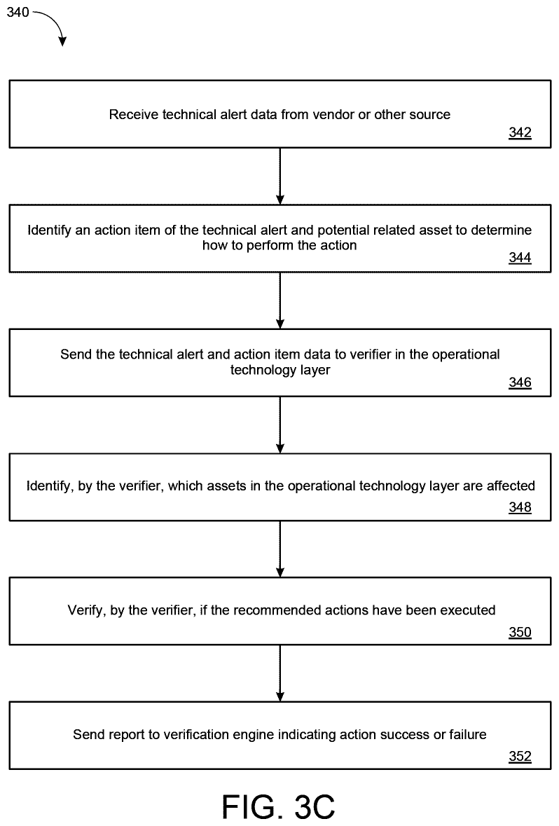

FIGS. 3A, 3B, and 3C each shows a block diagram illustrating a respective example process 300, 320, 340 for generating recommended actions for mitigation of issues in OT systems, according to some implementations of the present disclosure. For clarity of presentation, the description that follows generally describes the example process 300, 320, 340 in the context of the other figures in this description. However, it will be understood that the example process 300, 320, 340 can be performed, for example, by any suitable system, environment, software, and hardware, or a combination of systems, environments, software, and hardware, as appropriate. In some implementations, various steps of the example process 300, 320, 340 can be run in parallel, in combination, in loops, or in any order.

FIG. 3A shows a process 300 to generate recommended actions for identified TAs from vendor systems. As described previously, the process 300 includes fetching (302) technical alerts automatically from manufacturing vendor. The process 300 includes classifying the technical alert type and/or technical alert source using TA classifier 122. The data processing system identifies (306) the target asset and determines (308) the recommended action for implementation at the target asset, such as by classifier 112 as described previously. The data processing system generates (310) a notification of technical alert to end user and presents it, such as at interface 132.

FIG. 3B shows a process 320 to update the asset data based on whether a recommended action, such as by process 300, was successful or not. In process 320, the data processing system 100 scans (322) a target assets of the network of the operational technology system periodically or responsive to a particular request. The data processing system 100, for identified target assets, determines (324) asset data that gives a status of the asset after the recommended action was implemented. The data processing system 100 determines (326) a variance of asset data for one or more assets to expected asset data for that asset. This variance, as previously discussed, can identify whether the recommended action was successful or not. The data processing system can update (238) the asset data store with the variance data showing any changes to the asset after the recommended was implemented. The data processing system 100 can generate (330) a notification of potential technical alert that applies to asset in which expected asset data does not match determined asset data, which can indicate that further investigation or review is needed.

FIG. 3C shows a process 340 for verification of success or failure of an action, such as for performing process 320. The data processing system 100 can receive (342) technical alert data from vendor or other source. The data processing system can identify (344) an action item of the technical alert and potential related asset to determine how to perform the action. The data processing system can send (346) the technical alert and action item data to verifier in the operational technology layer. The data processing system can identify (348), by the verifier, which assets in the operational technology layer are affected. The data processing system 100 can verify (350), by the verifier, if the recommended actions have been executed. The data processing system can send (352) report to verification engine indicating action success or failure.

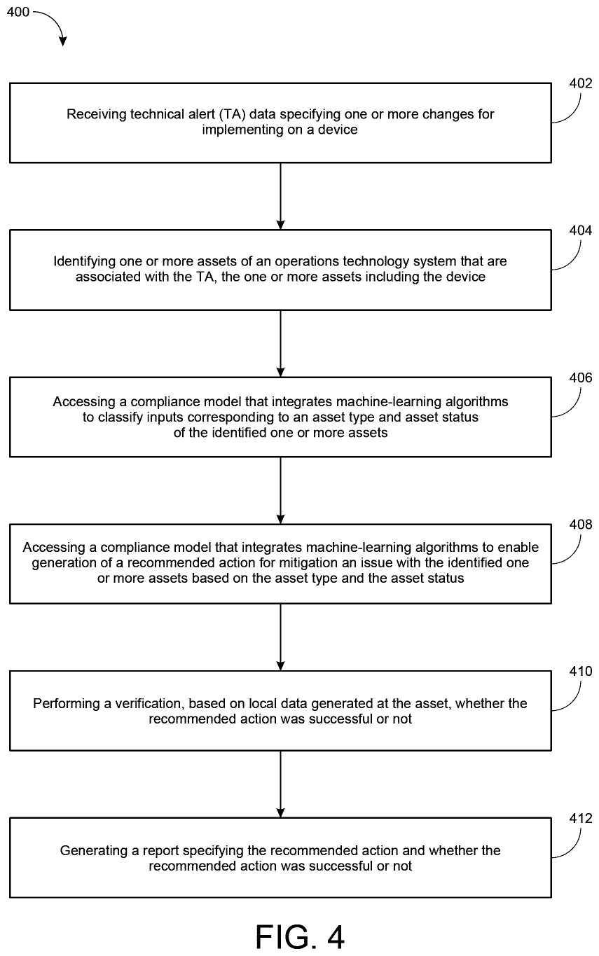

FIG. 4 shows a block diagram illustrating an example process 400 for controlling an operations technology system of a hydrocarbon production facility for mitigation of issues in OT systems, according to some implementations of the present disclosure. For clarity of presentation, the description that follows generally describes method 400 in the context of the other figures in this description. However, it will be understood that method 400 can be performed, for example, by any suitable system, environment, software, and hardware, or a combination of systems, environments, software, and hardware, as appropriate. In some implementations, various steps of method 400 can be run in parallel, in combination, in loops, or in any order.

The process 400 includes receiving (402) technical alert (TA) data specifying one or more changes for implementing on a device. The process 400 includes identifying (404) one or more assets of an operations technology system that are associated with the TA, the one or more assets including the device. The process 400 includes accessing a compliance model that integrates machine-learning algorithms to: classify (406) inputs corresponding to an asset type and asset status of the identified one or more assets and enable generation (408) of a recommended action for mitigation an issue with the identified one or more assets based on the asset type and the asset status. The process 400 includes performing (410) a verification, based on local data generated at the asset, whether the recommended action was successful or not. The process 400 includes generating (412) a report specifying the recommended action and whether the recommended action was successful or not.

In some implementations, the process 400 includes training the compliance model by: querying data from a verifier installed at an operations technology layer including the identified one or more assets; determining variance data of asset data for the one or more assets compared to expected data for the one or more assets; updating asset data with the variance data; labelling the recommended action with the variance data to generate labelled data; and retraining the compliance model using the labelled data.

In some implementations, the one or more assets include physical hardware in a hydrocarbon production facility, and wherein the recommended action includes controlling operation of the hardware. In some implementations, controlling operation of the hardware comprises quarantining the hardware from transmitting or receiving data from other assets of the operational technology system.

In some implementations, the process 400 includes generating a validation request for approval by a user prior to implementing the recommended action, wherein generating the validation request is based on a confidence of a prediction of the recommended action.

In some implementations, the process 400 includes classifying the TA data based on a source of the TA data, wherein the generation of the recommended action is based on the source of the TA data.

In some implementations, the process 400 includes, responsive to determining that the recommended action was not successful, reverting operation of the one or more assets to a state prior to detection of an issue related to the TA data.

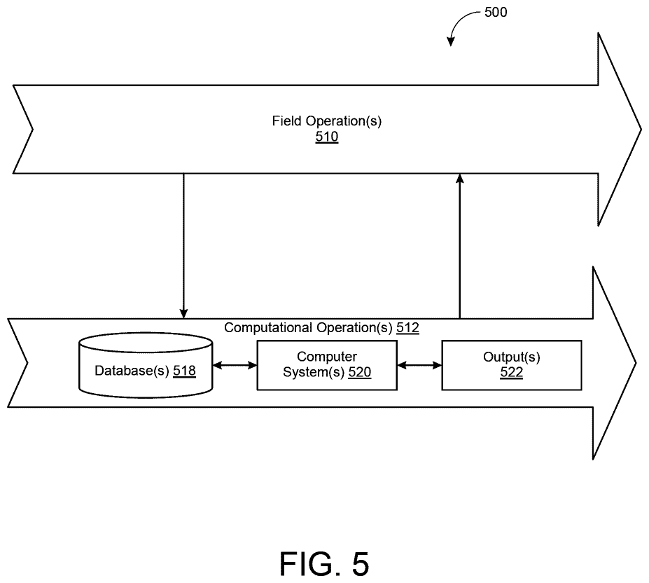

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure (e.g., the method 400) can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively, or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, considering processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

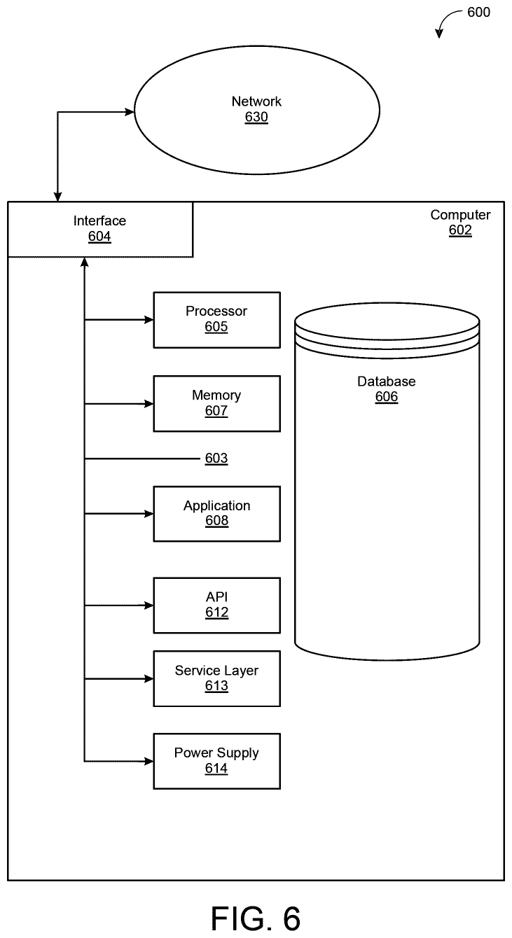

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user-or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

What is claimed is:

1. A method for controlling an operations technology system of a hydrocarbon production facility, the method comprising:
receiving technical alert (TA) data specifying one or more changes for implementing on a device;
identifying one or more assets of an operations technology system that are associated with the TA, the one or more assets including the device;
accessing a compliance model that integrates machine-learning algorithms to:
classify inputs corresponding to an asset type and asset status of the identified one or more assets, and
enable generation of a recommended action for mitigation an issue with the identified one or more assets based on the asset type and the asset status;
performing a verification, based on local data generated at the asset, whether the recommended action was successful or not; and
generating a report specifying the recommended action and whether the recommended action was successful or not.

2. The method of claim 1, further comprising training the compliance model by:
querying data from a verifier installed at an operations technology layer including the identified one or more assets;
determining variance data of asset data for the one or more assets compared to expected data for the one or more assets;
updating asset data with the variance data;
labelling the recommended action with the variance data to generate labelled data; and
retraining the compliance model using the labelled data.

3. The method of claim 1, wherein the one or more assets include physical hardware in a hydrocarbon production facility, and wherein the recommended action includes controlling operation of the hardware.

4. The method of claim 3, wherein controlling operation of the hardware comprises quarantining the hardware from transmitting or receiving data from other assets of the operational technology system.

5. The method of claim 1, further comprising generating a validation request for approval by a user prior to implementing the recommended action, wherein generating the validation request is based on a confidence of a prediction of the recommended action.

6. The method of claim 1, further comprising:
classifying the TA data based on a source of the TA data, wherein the generation of the recommended action is based on the source of the TA data.

7. The method of claim 1, further comprising, responsive to determining that the recommended action was not successful, reverting operation of the one or more assets to a state prior to detection of an issue related to the TA data.

8. A system for controlling an operations technology system of a hydrocarbon production facility, the system comprising:
at least one processor; and
a memory storing instructions that, when executed by the at least one processor, cause the at least one processor to perform operations comprising:
receiving technical alert (TA) data specifying one or more changes for implementing on a device;
identifying one or more assets of an operations technology system that are associated with the TA, the one or more assets including the device;
accessing a compliance model that integrates machine-learning algorithms to:
classify inputs corresponding to an asset type and asset status of the identified one or more assets, and
enable generation of a recommended action for mitigation an issue with the identified one or more assets based on the asset type and the asset status;
performing a verification, based on local data generated at the asset, whether the recommended action was successful or not; and
generating a report specifying the recommended action and whether the recommended action was successful or not.

9. The system of claim 8, the operations further comprising training the compliance model by:
querying data from a verifier installed at an operations technology layer including the identified one or more assets;
determining variance data of asset data for the one or more assets compared to expected data for the one or more assets;
updating asset data with the variance data;
labelling the recommended action with the variance data to generate labelled data; and
retraining the compliance model using the labelled data.

10. The system of claim 8, wherein the one or more assets include physical hardware in a hydrocarbon production facility, and wherein the recommended action includes controlling operation of the hardware.

11. The system of claim 10, wherein controlling operation of the hardware comprises quarantining the hardware from transmitting or receiving data from other assets of the operational technology system.

12. The system of claim 8, the operations further comprising generating a validation request for approval by a user prior to implementing the recommended action, wherein generating the validation request is based on a confidence of a prediction of the recommended action.

13. The system of claim 8, the operations further comprising:
classifying the TA data based on a source of the TA data, wherein the generation of the recommended action is based on the source of the TA data.

14. The system of claim 8, the operations further comprising, responsive to determining that the recommended action was not successful, reverting operation of the one or more assets to a state prior to detection of an issue related to the TA data.

15. One or more non-transitory computer readable media storing instructions for controlling an operations technology system of a hydrocarbon production facility, the instructions, when executed by at least one processor, configured to cause the at least one processor to perform operations comprising:
receiving technical alert (TA) data specifying one or more changes for implementing on a device;
identifying one or more assets of an operations technology system that are associated with the TA, the one or more assets including the device;
accessing a compliance model that integrates machine-learning algorithms to:
classify inputs corresponding to an asset type and asset status of the identified one or more assets, and
enable generation of a recommended action for mitigation an issue with the identified one or more assets based on the asset type and the asset status;
performing a verification, based on local data generated at the asset, whether the recommended action was successful or not; and
generating a report specifying the recommended action and whether the recommended action was successful or not.

16. The one or more non-transitory computer readable media of claim 15, the operations further comprising training the compliance model by:
querying data from a verifier installed at an operations technology layer including the identified one or more assets;
determining variance data of asset data for the one or more assets compared to expected data for the one or more assets;
updating asset data with the variance data;
labelling the recommended action with the variance data to generate labelled data; and
retraining the compliance model using the labelled data.

17. The one or more non-transitory computer readable media of claim 15, wherein the one or more assets include physical hardware in a hydrocarbon production facility, and wherein the recommended action includes controlling operation of the hardware.

18. The one or more non-transitory computer readable media of claim 17, wherein controlling operation of the hardware comprises quarantining the hardware from transmitting or receiving data from other assets of the operational technology system.

19. The one or more non-transitory computer readable media of claim 15, the operations further comprising generating a validation request for approval by a user prior to implementing the recommended action, wherein generating the validation request is based on a confidence of a prediction of the recommended action.

20. The one or more non-transitory computer readable media of claim 15, the operations further comprising:
classifying the TA data based on a source of the TA data, wherein the generation of the recommended action is based on the source of the TA data.
